(19) United States
(12) Patent Application Publication
(10) Pub. No.: US 2007/0119974 A1
(43) Pub. Date: May 31, 2007

(54) Combined valve, filter, and regulator irrigation apparatus

(75) Inventor: Christopher Scott Johnson, Woods Cross, UT (US)

Correspondence Address: KENNETH E. HORTON;KIRTON & MCCONKLE, 60 EAST SOUTH TEMPLE, SUITE 1800, SALTLAKE CITY, UT, 84111, US

(73) Assignee: Orbit Irrigation Products, Inc.

(21) Appl. No.: 11/254,187

(22) Filed: Oct. 19, 2005

(51) Int. Cl. B05B 15/06; E01H 3/04; B05B 15/10

(52) U.S. Cl. 239/200; 239/201; 239/202; 239/203

(57) ABSTRACT

Irrigation apparatus and methods for using such apparatus in irrigation are described. The irrigation apparatus combines the function of a regulator, valve, and filter into a single unit, rather than merely connecting the three separate devices to each other using pipe. Incorporating the functions of the three separate devices into a single unit allows a smaller size to be used, making it quicker and easier to install and/or replace in the limited space provided by irrigation boxes. Using a single apparatus alternatively allows a smaller irrigation box to be used, saving on costs.

### FIELD OF THE INVENTION

The invention generally relates to irrigation apparatus and methods for using such apparatus. More particularly, the invention relates to irrigation apparatus that have multiple functions and methods for using such apparatus. Even more particularly, the invention relates to irrigation apparatus that combine the functions of a regulator, valve, and filter devices into a single apparatus or unit.

### BACKGROUND OF THE INVENTION

There are many types of irrigation systems containing irrigation devices that are known in the art. See, for example, U.S. Pat. Nos. 6,932,277, 6,874,696, D500,122, D498,515, D498,513, D497,973, 6,792,962, D495,026, D494,656, 6,749,136, 6,682,106, D482,428, 6,619,570, 6,592,053, 6,530,531, 6,337,635, D451,981, and D392,619, the disclosures of which are incorporated herein by reference. One common type of irrigation device is a sprinkler that distributes water over an area with a specific spray pattern. Water is generally delivered to the sprinkler via a system of pipes.

To deliver water to the pipe system (and therefore to the sprinklers), several types of irrigation devices are used. The first irrigation device is a regulator, which functions to regulate and control the pressure of the water in the pipe system. If the water pressure (which depends on the size of the pipes and the material of the pipes) becomes too high, the pipes might burst.

The second type of irrigation device used in delivering the water to the pipe system and sprinklers is a filter. A filter is used to remove debris and contaminants from the water. To meet the smaller size required of sprinklers, the components in the sprinkler are fit together in a tight configuration. When debris and other contaminants are allowed to enter the sprinkler, this tight configuration can be disrupted, resulting in water leakage and water loss.

The third irrigation device used to deliver the water to the pipe system and sprinklers is a valve. The valve can open to allow water to pass through it to the pipe systems and sprinklers, or can close to prevent the flow of water. The valves typically open and close automatically for pre-selected times by connecting each valve to an electronic controller.

These three irrigation devices are typically placed as close together in an irrigation system so that a user can access all three devices at the same time without going to different locations in the system. To meet this goal, these three irrigation devices are often placed in an irrigation “box” in the ground. This placement also allows the irrigation devices to be buried under the ground and hidden from sight, as well as protecting them form accidental damage that occurs if they are located above the ground.

For purposes of standardization, the irrigation boxes are typically only made is specific sizes, i.e., 12 inches and 20 inches.

FIG. 1 shows an example of how these three irrigation devices are typically combined together in an irrigation box using a pipe 10 between each device. In FIG. 1, the water enters the combined system of devices 1 though inlet 2 and then flows to the valve 8. If the valve 8 is open, the water flows through the filter 6 and then to the regulator where the water flows out the exit 12. If the valve 8 is closed, the water is not released past the valve.

FIG. 1 shows a common configuration where these three irrigation devices are placed as close as possible to each together to conserve space, yet far enough apart so they operate as intended while allowing a user to access each device (i.e., for replacement). Even so, the length of the combined devices generally is more than 12 inches and, as depicted in FIG. 1, is about 14 inches. And with such lengths, the irrigation box that must used to enclose the three combined devices is the 20 inch size. Using the 12 inch box does not leave much room in the irrigation box for the user to install and/or replace any of the three individual devices, making installation and replacement difficult. Other disadvantages with the three connected devices include that the larger irrigation boxes needed to enclose them are expensive, multiple connections between the three irrigation devices result in multiple leakage failure points, and typically the 3 irrigation devices must be purchased from 3 different vendors, making purchasing cumbersome.

### SUMMARY OF THE INVENTION

The invention relates to irrigation apparatus and methods for using such apparatus in irrigation. The irrigation apparatus combines the function of a regulator, valve, and filter into a single unit, rather than merely connecting the three separate devices. Incorporating the functions of the three separate devices into a single unit allows a smaller size to be used, making it quicker and easier to install and/or replace in the limited space provided by irrigation boxes. As well, less leakage occurs because there are fewer connections. Using a single apparatus alternatively allows a smaller irrigation box to be used, saving on costs.

### BRIEF DESCRIPTION OF THE DRAWINGS

The following description of the invention can be understood in light of the Figures, in which:

FIG. 1 depicts a conventional irrigation system containing a regulator, filter, and valve;

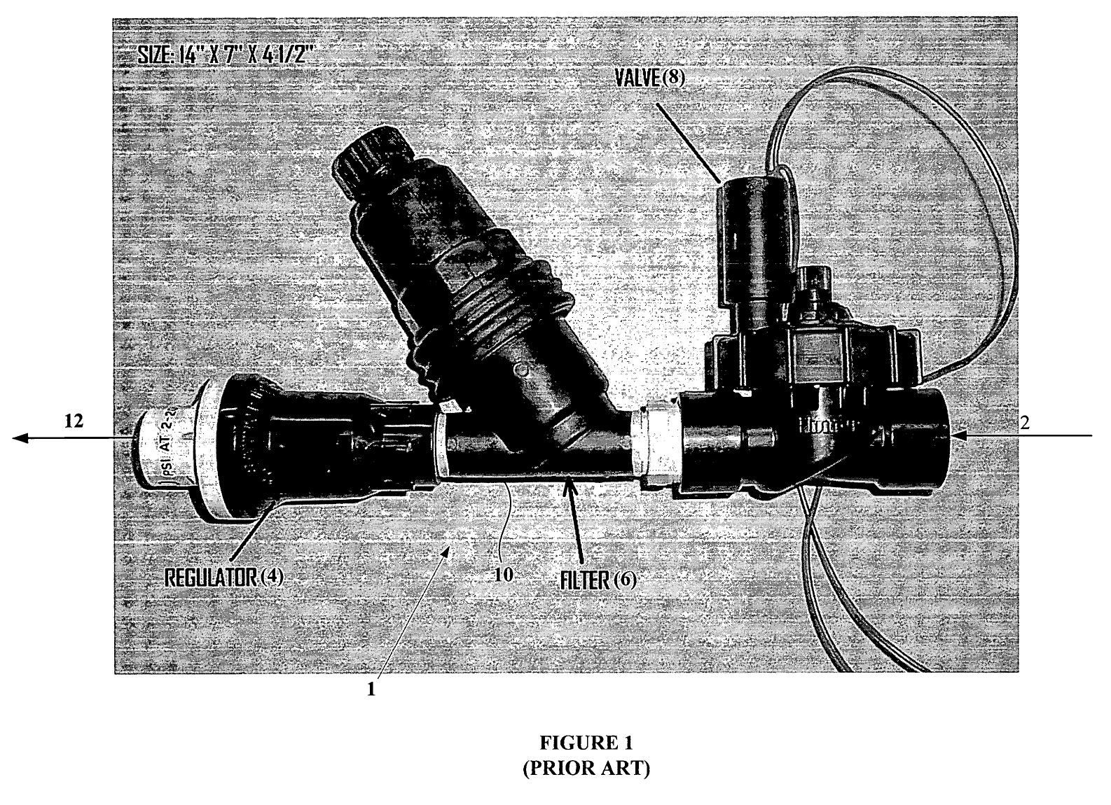

FIG. 2 depicts a multi-functional irrigation unit in one aspect of the invention;

FIG. 3 depicts a multi-functional irrigation unit in another aspect of the invention; and

FIG. 4 depicts a multi-functional irrigation unit in another aspect of the invention; and

FIG. 5 depicts an irrigation apparatus in yet another aspect of the invention.

The Figures illustrate specific aspects of the invention and are a part of the specification. In the Figures, the thickness and configuration of components may be exaggerated for clarity. The same reference numerals in different drawings represent the same component. Together with the following description, the Figures demonstrate and explain the principles of the invention.

### DETAILED DESCRIPTION OF THE INVENTION

The following description provides specific details in order to provide a thorough understanding of the invention. The skilled artisan, however, would understand that the invention can be practiced without employing these specific details. Indeed, the invention can be practiced by modifying the illustrated method and resulting product and can be used in conjunction with apparatus and techniques conventionally used in the industry. While the invention is described for use with sprinkling systems, it could be used for any irrigation purpose, such as for ditch irrigation, terrace irrigation, drip (or trickle) irrigation, and sub-irrigation.

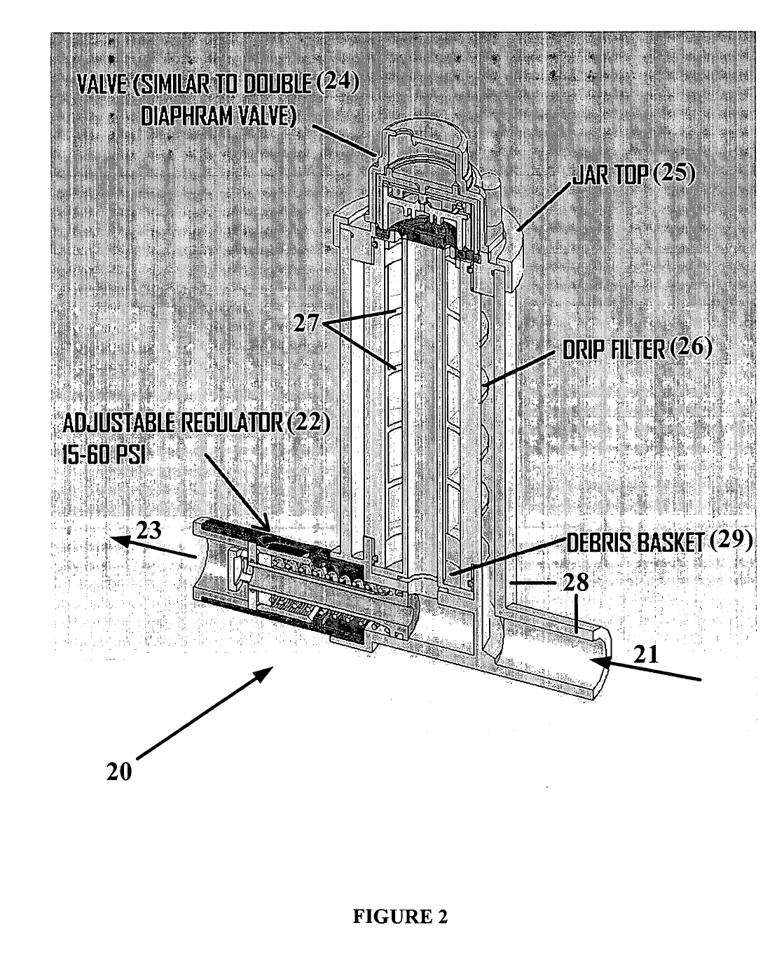

As described above, the invention includes irrigation apparatus that combine the functions of a regulator, filter, and a valve into a single—but multi-functional—apparatus or unit. Any apparatus or unit that meets these criteria can be used, including any of those depicted in FIGS. 2-5 and described below.

In one aspect of the invention, the irrigation unit contains three portions for the three functions. A first portion of the irrigation apparatus comprises means for controlling the flow of water through the apparatus. A second portion of the irrigation apparatus comprises means for cleaning the water flowing through the apparatus. A third potion of the irrigation apparatus contains means for stopping the flow of the water through the apparatus.

The means for controlling the flow of water can be any means known in the art, including a partial mechanical obstruction placed and removed by manual, mechanical, or hydraulic movements. In one aspect of the invention, the controlling means comprises an adjustable regulator for maintaining the pressure of the water within a desired range. The desired range will depend on the size and material of the pipe. In the aspect of the invention where the irrigation unit is used with PVC pipes, the pressure can range from about 10 to about 120 psi, and in particular, about 15 to about 60 psi.

The means for cleaning the flow of water can be any means known in the art, including forcing the flow of water through filters that do not allow debris in the water from passing through them. In one aspect of the invention, the cleaning means comprises a filter for removing substantially all the particulates in the water. The amount—and size—of particulates removed will depend on the size of the opening(s) in the filter, as well as the other components in the irrigation system (i.e., the tolerances permitted by the sprinklers used). In the aspect of the invention where 32 mesh filters are used, the filter will remove particulates ranging from about 700 to about 800 microns in size.

The means for stopping the flow of water can be any means known in the art, including a full mechanical obstruction placed and removed by manual, mechanical, or hydraulic movements. In one aspect of the invention, the stopping means comprises a valve capable of partially or completing halting the flow of water. The specific type of valve used will depend on size constraints. Examples of the types of valves that can be used include any of those commercially available.

In one aspect of the invention, the irrigation apparatus or unit of the invention is depicted in FIG. 2. In FIG. 2, the irrigation apparatus or unit 20 contains an adjustable regulator 22, a valve 24, and a filter 26 all contained within a single manifold 28. Thus, the irrigation apparatus is a single unit capable of performing all three of these functions. The manifold 28 can be made as a single piece, or as depicted in FIG. 2, more than one piece that can be connected or attached to each other.

The adjustable regulator 22 operates as the controlling means. The adjustable regulator 22 is capable of the adjusting the pressure within a specified range, i.e., ± about 15 psi, normally within the operating range of about 15 to about 60 psi. Any adjustable regulator known in the art can be used in the invention, including those using a spring and its deflection to absorb energy and reduce the pressure.

The irrigation apparatus 20 also contains a valve 24 that operates as the stopping means. The valve 24 can be any valve known in the art, including those commercially available. In one aspect of the invention, the valve 24 is configured substantially similar to a double-diaphragm valve, thereby providing increased reliability.

The irrigation apparatus also contains a filter 26 that operates as the cleaning means. Any filter known in the art can be used, including those commercially available. In one aspect of the invention, the filter 26 is a drip-type filter where the water flows down through the successive trays 27 and then back into the manifold 28. Excess debris is retained in the debris basket 29 and can be removed when the filter 26 is replaced and/or regularly cleaned by removal from the apparatus using the top 25. The filter has a flushing mechanism where water washes the surface of the filter to remove the debris and then the water containing the debris is permitted to exit the filtering chamber when a user manually removes a cap at the top of the filter chamber.

The irrigation apparatus 20 operates in the following manner. The water enters through the manifold 28 from the upstream side 21 of the device 20. The water flows up to the valve 24, where it is either stopped or continues to flow depending on the setting of the valve 24. When the water flows past the valve, it flows down through the filter 26, and then into the manifold 28, and then exits the downstream side 23 of the device. The regulator 22 operates to keep the pressure within the desired operating range.

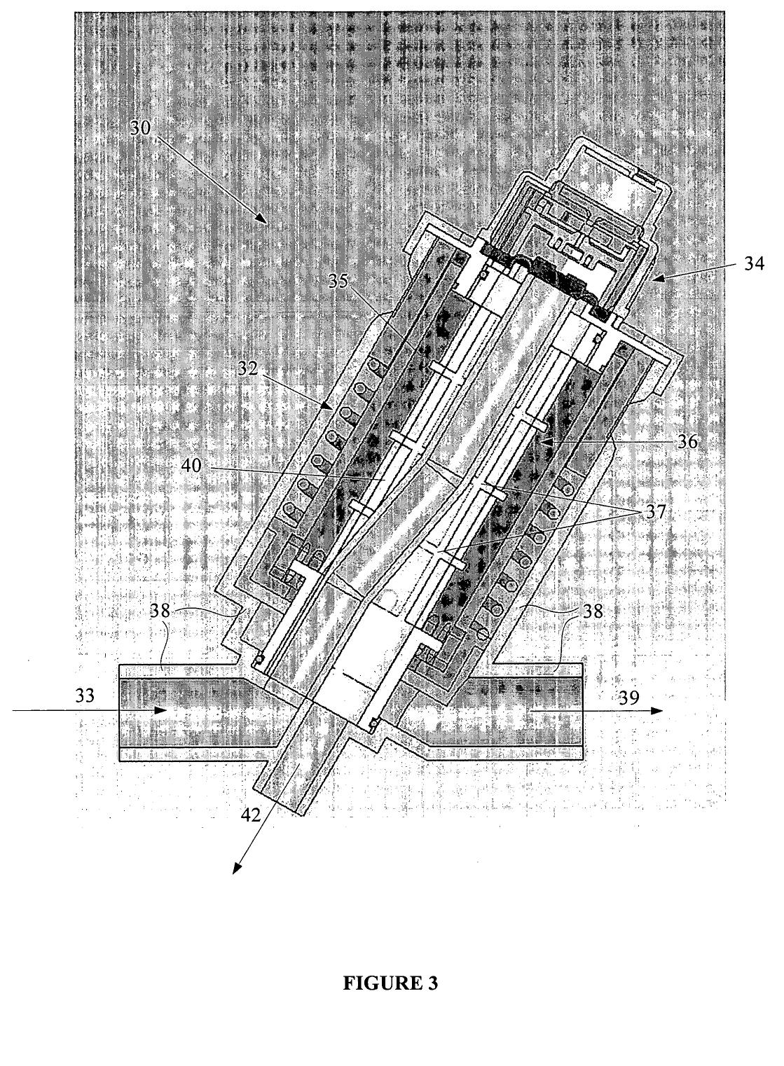

In another aspect of the invention, the irrigation apparatus is depicted in FIG. 3. In FIG. 3, the irrigation apparatus 30 is configured with a “y” shape, rather than the T-shape shown in FIG. 2, thereby reducing the height requirements of the unit. The “y” shape is formed because an acute angle is formed between the two main parts of the manifold. The angle of this acute angle can range from about 1 to about 45 degrees.

The irrigation apparatus 30 contains an adjustable regulator 32, a valve 34, and a filter 36 all contained within a single manifold 38. Thus, the irrigation apparatus 30 is also a single unit or apparatus. The manifold 38 can also be made as a single piece (as illustrated in FIG. 3) or more than one piece that can be connected or attached to each other.

The regulator 32 operates as the controlling means. The adjustable regulator 32 is capable of the adjusting the pressure within a specified range, i.e., ± about 15 psi, normally within the operating range of about 15 to about 60 psi. Any adjustable regulator known in the art can be used in the invention, those using a spring and its deflection to absorb energy and reduce the pressure. Rather than being located in the horizontal part of the manifold, the regulator 32 has been incorporated into the vertical portion of the manifold.

The irrigation apparatus 30 also contains a valve 34 that operates as the stopping means. The valve 34 can be any valve known in the art, including those commercially available. In one aspect of the invention, the valve 34 is configured substantially similar to a double-diaphragm valve, thereby providing increased reliability.

The irrigation apparatus also contains a filter 36 that operates as the cleaning means. Any filter known in the art can be used, including those commercially available. In one aspect of the invention, the filter 36 is a drip type filter where the water flows down through the successive trays 37 and then back into the manifold 38.

The irrigation apparatus 30 operates in the following manner. The water enters through the manifold 38 from the upstream side 33 of the device 30. The water flows to the valve 34, where it is either stopped or continues to flow depending on the setting of the valve. When the water flows past the valve 34, it flows down through the outer surface 35 of the filter 36, then into the manifold 38, and finally exits the downstream side 39 of the apparatus 30. The regulator 32 operates to keep the upstream pressure within the desired operating range.

The irrigation apparatus 30 can also be configured to allow a quick and easy flushing operation. In this configuration, the valve 34 is partially opened to allow the water to flow through the inner surface 40 of the filter 36 and then out the flushing exit 42. Such a configuration can be used to easily allow the filter to be cleaned without removing any portion of the valve from the apparatus 30.

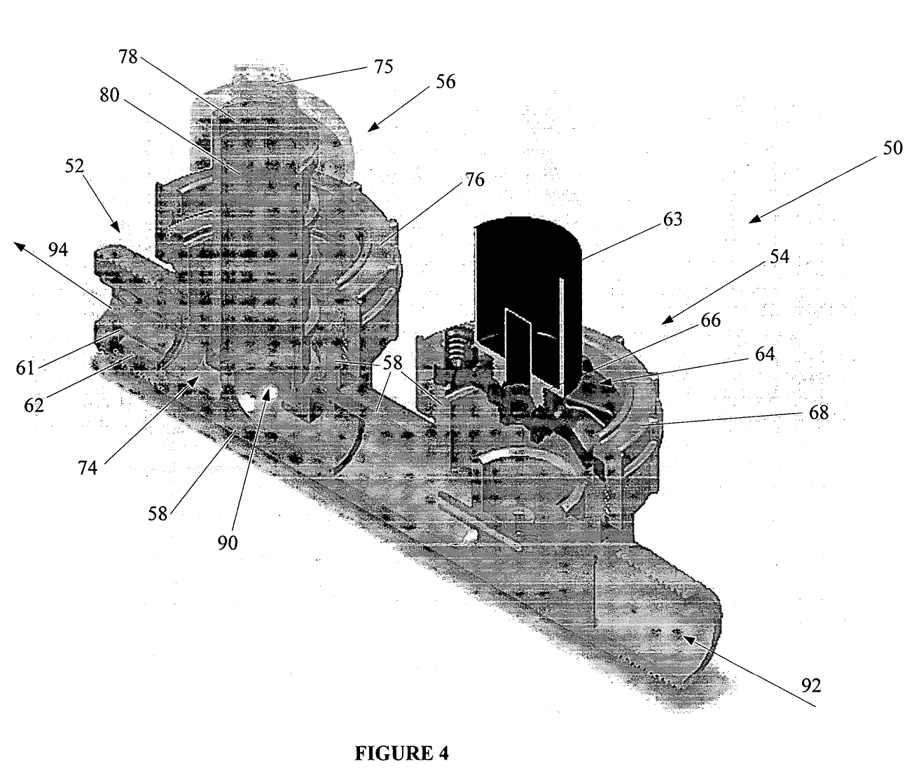

In yet another aspect of the invention, the irrigation apparatus or unit is depicted in FIG. 4. In FIG. 4, the irrigation apparatus 50 contains an adjustable regulator 52, a valve 54, and a filter 56 all contained within a single manifold 58. Thus, the irrigation apparatus 40 is also a single unit. The manifold 58 can be made as a single piece or more than one piece that can be connected or attached to each other.

The regulator 52 operates as the controlling means. The adjustable regulator 52 is capable of the adjusting the pressure within a specified range, i.e., ± about 15 psi, normally within the operating range of about 15 to about 60 psi. Any adjustable regulator known in the art can be used in the invention, including those described above. In this aspect of the invention, the regulator 52 contains a piston 61 and a fastener 62 that work together as known in the art to provide the regulating function.

The irrigation apparatus 50 also contains a valve 54 that operates as the stopping means. The valve 54 can be any valve known in the art, including those described above. In one aspect of the invention, the valve 54 contains any solenoid 63 that operates to stop (or release) the flow of the water as known in the art. The valve 54 also contains a lid 64 with ribs 66 in which the solenoid 63 seats. The valve 54 also contains a top 68 that is configured to connect to the manifold 58 using any suitable connection means known in the art, such as matching threads.

The irrigation apparatus 50 also contains a filter 56 that operates as the cleaning means. Any filter known in the art can be used, including those described above. In one aspect of the invention, the filter 56 contains a filter support 74 connecting the regulator 52 and the filter 56. The filter also contains a lid 75, as well as a top 76 that is configured to connect to the manifold 58 using any suitable connection means known in the art, such as matching threads. The filter 56 also contains a frame 78 and mesh 80, both of which operate as known in the art. The filter 56 also contains the manifold receiver 90 for directing the flow of the water from the filter back to the manifold.

The irrigation apparatus 50 operates in the following manner. The water enters through the manifold 58 from the upstream side 92 of the device 40. The water then flows to the valve 54, where it is either stopped or continues to flow depending on position of the solenoid 63. When it passes the valve, the water flows through the filter receiver 90 and then through the filter 56. The water then flows through the filter support 74 into the manifold 58, through the regulator 52, and exits the downstream side 94 of the device. The regulator 52 operates to keep the pressure within the desired operating range.

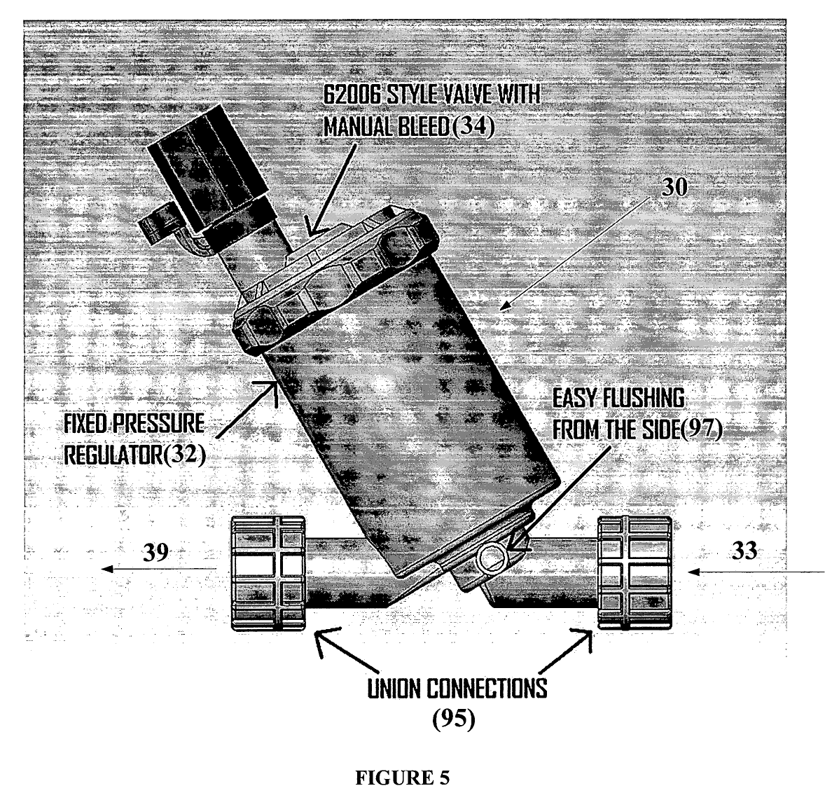

Any of the irrigation apparatus of the invention, including those described above, can be easily connected to—and work with—the pipes of an irrigation system. An example of one such connection is illustrated in FIG. 5, which depicts the exterior of the irrigation apparatus 30. The irrigation apparatus 30 is contained within the manifold 38. Both the upstream end 33 and the downstream end 39 contain suitable connection means for the pipes (not shown). An exemplary connection means are union connections 95. The exterior of the irrigation apparatus 30 also contains the exit 97 for the flushing mechanism of irrigation apparatus 30.

The irrigation apparatus of the invention can be modified to contain additional or optional features, including any of those described in the patents mentioned above. For example, the irrigation apparatus can contain any known feature that enhances any of its functions, including using multiple valves with any single regulator/filter combination.

The irrigation apparatus of the invention can also be made as part of an irrigation system. Other components of an irrigation system could include any known mechanism for delivering the water to the irrigation apparatus, such as an upstream piping system, a pump, and/or electrical connection for the valves (along with any suitable electronic controller).

There exist numerous advantages with the irrigation apparatus of the invention. First, since it combines the functions of a valve, filter, and regulator in a single unit, which can be easily and quickly installed and/or replaced. Second, for a given space, it is smaller than conventional devices and allows easier access by a user. The length of the irrigation apparatus of the invention generally can range up to 12 inches, and generally ranges from about 8 up to about 9 inches. In one configuration, the length is about 8½ inches.

The third advantage is that since it is a single unit, fewer materials have to be expended to make it, reducing costs while allowing industry standard parts to be used. Fourth, it uses a filter that is easy to clean, a valve that is very reliable, and a regulator that is easy to adjust.

The irrigation apparatus of the invention can be made by any process that provides the structures described above. In one aspect of the invention, the conventional components of the irrigation device are obtained using conventional manufacturing methods and then assembled as known in the art.

In addition to any previously indicated variation, numerous other modifications and alternative arrangements may be devised by those skilled in the art without departing from the spirit and scope of the invention and appended claims are intended to cover such modifications and arrangements. Thus, while the invention has been described above with particularity and detail in connection with what is presently deemed to be the most practical and preferred aspects of the invention, it will be apparent to those of ordinary skill in the art that numerous modifications, including but not limited to, form, function, manner of operation and use may be made without departing from the principles and concepts set forth herein.

What is claimed is:

1. An irrigation apparatus contained within a single unit, the apparatus comprising:
means for controlling the flow of water;
means for cleaning the flow of water; and
means for stopping the flow of water.

2. The apparatus of claim 1, wherein the controlling means comprises an adjustable regulator.

3. The apparatus of claim 2, wherein the regulator controls the flow of water within a pressure range of about 15 psi to about 60 psi.

4. The apparatus of claim 1, wherein the cleaning means comprises a filter.

5. The apparatus of claim 4, wherein the filter can be cleaned without removing it from the apparatus.

6. The apparatus of claim 1, wherein the stopping means comprises a valve.

7. The apparatus of claim 1, wherein the length of the apparatus is less than 12 inches.

8. The apparatus of claim 7, wherein the length of the apparatus ranges from about 8 to about 9 inches.

9. The apparatus of claim 8, wherein the length is about 8.5 inches.

10. An irrigation apparatus, comprising a single manifold containing:
an adjustable regulator;
a filter; and
a valve.

11. The apparatus of claim 10, wherein the regulator controls the flow of water within a pressure range of about 15 psi to about 60 psi.

12. The apparatus of claim 11, wherein the filter can be cleaned without removing it from the apparatus.

13. The apparatus of claim 11, wherein the length of the apparatus ranges up to 12 inches.

14. The apparatus of claim 13, wherein the length of the apparatus ranges from about 8 to about 9 inches.

15. The apparatus of claim 14, wherein the length is about 8.5 inches.

16. A single-unit irrigation apparatus, comprising an adjustable regulator, a filter, and a valve contained within a single manifold, the apparatus having a length of less than 12 inches.

17. The apparatus of claim 16, wherein the length of the apparatus ranges from about 8 to about 9 inches.

18. The apparatus of claim 17, wherein the length is about 8.5 inches.

19. An irrigation system containing single-unit irrigation apparatus, the apparatus comprising an adjustable regulator, a filter, and a valve contained within a single manifold, with the apparatus have a length of less than 12 inches.

20. A method of irrigation, comprising:
providing a single-unit irrigation apparatus, the apparatus comprising an adjustable regulator, a filter, and a valve contained within a single manifold, with the apparatus have a length of less than about 12 inches; and
flowing water through the apparatus.
